(19) United States
(12) Patent Application Publication
(10) Pub. No.: US 2025/0098606 A1
(43) Pub. Date: Mar. 27, 2025

(54) Method For Growing Leaf Vegetables and/or Herbs and/or Potato Plants And Device There For

(71) Applicants: Ronaldus Cornelis Maria PETERS, Meppel (NL); FERR TECH B.V., Meppel (NL)

(72) Inventors: Ronaldus Cornelis Maria PETERS, Meppel (NL); Sina SAMIMI-SEDEH, Meppel (NL); Robert Luc TISSINGH, Meppel (NL); Hendricus Johannes Richard BRUINS, Meppel (NL); Theun PETERS, Meppel (NL); Thomas PETERS, Meppel (NL)

(73) Assignee: FERR TECH B.V., Meppel (NL)

(21) Appl. No.: 18/722,741

(22) PCT Filed: Sep. 23, 2022
(86) PCT No.: PCT/NL2022/050536

§ 371 Date: Jun. 21, 2024

(30) Foreign Application Priority Data
Sep. 24, 2021 (NL) 2029252
Jan. 25, 2022 (NL) 2030699

(51) Int. Cl. A01G 31/02; A01G 22/15; A01G 22/25; A01G 31/00

(52) U.S. Cl. CPC A01G 31/02; A01G 22/15; A01G 22/25; A01G 31/011

(57) ABSTRACT

A method for growing leaf vegetables and/or herbs and/or potato plants, a device there for, a system there for, and use of ferrate for growing leaf vegetables and/or herbs and/or potato plants. The method includes providing a growth substrate, providing one or more leaf vegetable and/or herb and/or potato plant seeds and/or leaf vegetable plants and/or herb plants and/or potato plants to a growth substrate, providing growth media to the one or more leaf vegetable seeds and/or herb seeds and/or potato plant seeds and/or leaf vegetable plants and/or herb plants and/or potato plants, wherein the growth media at least comprises a liquid, and providing ferrate to the growth media.

The present invention relates to a method for growing leaf vegetables and/or herbs and/or potato plants, a device there for, an system there for, and use of ferrate for growing leaf vegetables and/or herbs and/or potato plants.

The human population is growing ever since, therefore efficient and effective food supply is preferred. To provide food, for example leaf vegetables and/or herbs and/or potato plants, fresh water is one of the main resources. It is know that fresh water is becoming scarcer.

Growing leaf vegetables and/or herbs and/or potato plants may be performed in a controlled environment. A disadvantage with conventional methods and/or devices for growing leaf vegetables and/or herbs and/or potato plants is that a large quantity of fresh water is required. The large quantity of water is required to prevent leaf vegetables and/or herbs and/or potato plants of dying. Therefore, growing leaf vegetables and/or herbs and/or potato plants in an aqueous environment in an environmental friendly manner is difficult and often impossible.

These problems prevent an efficient, effective, and environmental friendly method for growing leaf vegetables and/or herbs and/or potato plants. This problem is even bigger for large scale production as the amount of fresh water used to provide food, for example leaf vegetables and/or herbs and/or potato plants, is enormous.

The present invention aims at obviating or at least reducing the aforementioned problems and to enable efficient, effective, and environmental friendly production of food, such as leaf vegetables and/or herbs and/or potato plants. More specifically, the invention is aimed for providing a method for growing leaf vegetables and/or herbs and/or potato plants in an environmental friendly manner.

This objective is achieved with a method for growing leaf vegetables and/or herbs and/or potato plants, comprising the steps of:
providing a growth substrate;
providing one or more leaf vegetable and/or herb and/or potato plant seeds and/or leaf vegetable and/or herb and/or potato plants to a growth substrate;
providing growth media to the one or more leaf vegetable and/or herb and/or potato plant seeds and/or leaf vegetable and/or herb and/or potato plant plants, wherein the growth media at least comprises a liquid; and
providing ferrate to the growth media.

The method according to the invention relates to growing leaf vegetables and/or herbs and/or potato plants in a leaf vegetable and/or herb and/or potato plant growing system such as a hydroponics moving production system. Therefore, the method according to the invention may be performed to culture leaf vegetables and/or herbs and/or potato plants.

It is noted that leaf vegetables and/or herbs and/or potato plants refer to leaf vegetable plants and/or herb plants and/or potato plants of which the vegetables may be consumed by a consumer and/or may for example belong to the order of Caryophyllales and/or family of Amaranthaceae and/or genus of Spinacia. Leaf vegetables are for example spinach, endive, kale, napa cabbage, lettuce, chard, chicory, bok choy, lacinato kale, duckweed, and yellowcresses. Herbs are for example coriander, dill, and parsley. Potato plants may for example belong to the order of Solanales and/or family Solanaceae and/or genus of Solanum.

Furthermore, it is noted that providing a plant may be providing a cutting of a plant and/or a plant which may grow to full proportions and/or a grown-up plant.

In addition, potato plant seed refers to seeds for potato plants and/or potatoes for planting.

The method according to the invention for growing leaf vegetables and/or herbs and/or potato plants starts with the step of providing a growth substrate and providing one or more leaf vegetable seeds and/or herb seeds and/or potato plant seeds and/or leaf vegetable plants and/or herb plants and/or potato plants to growth substrate. Preferably, the growth substrate is a biodegradable growth substrate which enables plant growth. Preferably, the one or more leaf vegetable seeds and/or herb seeds and/or potato plant seeds and/or leaf vegetable plants and/or herb plants and/or potato plants are in substantially the same stage of their development. Said steps may be followed by the step of providing growth media to the one or more leaf vegetable seeds and/or herb seeds and/or potato plant seeds and/or leaf vegetable plants and/or herb plants and/or potato plants, wherein the growth media at least comprises a liquid. The growth media allows the one or more leaf vegetable seeds and/or herb seeds and/or potato plant seeds and/or leaf vegetable plants and/or herb plants and/or potato plants to grow. Said step may be followed by the step of providing ferrate to the growth media. In an alternative embodiment, the ferrate and the growth media are mixed before the growth media is provided to the one or more leaf vegetable seeds and/or herb seeds and/or potato plant seeds and/or leaf vegetable plants and/or herb plants and/or potato plants.

Providing ferrate to the growth media enables to grow leaf vegetables and/or herbs and/or potato plants efficiently and effectively and/or reduce the amount of water required to grow leaf vegetables and/or herbs and/or potato plants compared to conventional methods. It was found that providing ferrate to the growth media a stable environment for leaf vegetables and/or herbs and/or potato plants was achieved. The addition of the ferrate to the growth media reduces the fluctuation of the acidity level and/or nutrient level of the growth media. As a result, the amount of fresh water may be reduced and a lower environmental footprint is achieved.

A further advantage of the method according to the invention is that leaf vegetables and/or herbs and/or potato plants may be cultured in an aqueous system and/or the use of soil may be prevented. As a result, the growing rate of the leaf vegetables and/or herbs and/or potato plants is increased. Therefore, an efficient, effective and environmental friendly method for providing food is achieved.

Yet another advantage of the method according to the invention is that the method according to the invention improves the rhizosphere and/or production of fatty acids compared to conventional methods for growing leaf vegetables and/or herbs and/or potato plants. As a result, a stronger and/or more robust leaf vegetable and/or herb and/or potato plant is achieved. In addition, the improvement of the rhizosphere and/or production of fatty acids reduces or even superfluous the need of additional leaf vegetables and/or herbs and/or potato plants.

It was found that the method according to the invention enables leaf vegetables and/or herbs and/or potato plants in certain embodiments of the invention to grow in an aqueous system with a depth in the range of 0 mm to 5000 mm, preferably in an aqueous system with a depth in the range of 10 mm to 5000 mm, more preferably in an aqueous system with a depth in the range of 500 mm to 5000 mm, even more preferably in an aqueous system with a depth in the range of 1000 mm to 4000 mm, most preferably in an aqueous system with a depth in the range of 2500 mm to 4000 mm.

In a presently preferred embodiment according to the invention, the growth media comprise one or more selected from the group of water, fertilizer, nutrients, stabilizers. Preferably, the nutrient level may be in the range of 1 mM to 100 mM, preferably in the range of 1 mM to 50 mM, more preferably in the range of 10 mM to 50 mM.

It is noted that the growth media may be provided to the leaf vegetables and/or herbs and/or potato plants using for example deep water culture, table growing, propagation floors, gutters (MGS), open gutters, tower frames, aquaponics, airoponics, overhead watering, low tide/high tide system, and/or dripper system.

In a preferred embodiment according to the invention, the growth media comprises a nutrient level in the range of 0.5 to 6.0 EC, preferably in the range of 1.0 to 4.0 EC, more preferably in the range of 1.0 to 3.0 EC, even more preferably in the range of 1.5 to 2.5 EC.

It is noted that EC refers to electrical conductivity measured in Siemens per metre (S/m). It will be understood by the skilled person that electrical conductivity relates to electrical resistivity measured in ohm metre (Ω·m), wherein

Providing a growth media comprise one or more selected from the group of water, fertilizer, nutrients, stabilizers enable the leaf vegetable seeds and/or herb seeds and/or potato plant seeds and/or leaf vegetable plants and/or herb plants and/or potato plants in an efficient and effective manner. Preferably, the growth media comprises at least water and nutrients, wherein the nutrients are dissolved in water.

It was found that the ferrate enables to stabilize the acidity level of the water and/or nutrient level of the water. Therefore, the amount of water required to grow leaf vegetables and/or herbs and/or potato plants may be reduced as less fresh water may be used.

Furthermore, it was found that a nutrient level in the range of 1 mM to 100 mM, preferably in the range of 1 mM to 50 mM, more preferably in the range of 10 mM to 50 mM and/or a nutrient level in the range of 0.5 to 6.0 EC, preferably in the range of 1.0 to 4.0 EC, more preferably in the range of 1.0 to 3.0 EC, even more preferably in the range of 1.5 to 2.5 EC enables an efficient and effective growth of leaf vegetables and/or herbs and/or potato plants. In addition, it was found that providing ferrate to the growth media enabled to keep the nutrient level in said range.

In a further presently preferred embodiment according to the invention, the quantity of ferrate may be in the range of 0.01 cc m⁻³ liquid to 1000 cc m⁻³ liquid, preferably in the range of 0.1 cc m⁻³ liquid to 500 cc m⁻³ liquid, more preferably in the range of 1 cc m⁻³ liquid to 100 cc m⁻³ liquid, even more preferably in the range of 1 cc m⁻³ liquid to 75 cc m⁻³ liquid, even more preferably in the range of 1 cc m⁻³ liquid to 50 cc m⁻³ liquid, most preferably in the range of 2 cc m⁻³ liquid to 50 cc m⁻³ liquid.

Providing a quantity of ferrate in the range of 0.01 cc m⁻³ liquid to 1000 cc m⁻³ liquid, preferably in the range of 0.1 cc m⁻³ liquid to 500 cc m⁻³ liquid, more preferably in the range of 1 cc m⁻³ liquid to 100 cc m⁻³ liquid, even more preferably in the range of 1 cc m⁻³ liquid to 75 cc m⁻³ liquid, even more preferably in the range of 1 cc m⁻³ liquid to 50 cc m⁻³ liquid, most preferably in the range of 2 cc m⁻³ liquid to 50 cc m⁻³ liquid enables to stabilize the acidity level of the growth media. Therefore, the leaf vegetables and/or herbs and/or potato plants are prevented from dying and/or an efficient growth rate is achieved.

In a preferred embodiment, the growth media is provided to the one or more leaf vegetable seeds and/or herb seeds and/or potato plant seeds and/or leaf vegetable plants and/or herb plants and/or potato plants, wherein the growth media at least comprises a liquid, as a (liquid) flow. An advantage of a flow is that the growing conditions provided by the growth media may be stable.

In a further presently preferred embodiment according to the invention, the leaf vegetable seeds and/or leaf vegetable plants may be spinach. Preferably, the step of providing growth media comprises the step of providing 0.7 to 1.3 litre of liquid to 1 kilogram of harvestable spinach.

It was found that the method according to the invention provides exceptional results when the leaf vegetable seeds and leaf vegetable plants are spinach. For example, to grow 1 kilogram of spinach, which is suitable for consumption by a consumer, between 0.7 to 1.3 litre of water was used. In comparison, conventional methods to grow spinach to a similar quality require at least a tenfold of water under the same conditions.

In a preferred embodiment according to the invention, the herb seeds and/or herb plants may be one or more selected from the group of coriander, dill, and parsley.

In yet another preferred embodiment according to the invention, the potato plant seeds and/or potato plants may be one or more selected from the European Cultivated Potato Database, preferably, the potato plant seeds and/or potato plants may be one or more variety selected from the group of Yukon Gold, Jersey Royal, Opperdoezer Ronde, Linda potato, Marfona.

In a further presently preferred embodiment according to the invention, the step of providing ferrate to the growth media comprises the step of dissolving the ferrate in a solvent, preferably wherein the solvent is water.

To increase the rate of stabilising the acidity level, the ferrate may be dissolved in a solvent before provided to the growth media, wherein the solvent is preferably water. As a result, the leaf vegetables and/or herbs and/or potato plants experience less stress of the environment.

In a further presently preferred embodiment according to the invention, the ferrate may be ferrate (VI).

It was found that the method according to the invention provides efficient and effective leaf vegetable and/or herb and/or potato plant growth when the ferrate provided to the growth media is ferrate (VI).

In a further presently preferred embodiment according to the invention, the method according to the invention further comprises the step of measuring one or more selected from the group of temperature, pH, nutrient level, flow, and volume of the growth media.

The step of measuring one or more selected from the group of temperature, pH, nutrient level, flow, and volume of the growth media, enables to monitor the growing condition of the leaf vegetables and/or herbs and/or potato plants. An advantage is that a change in growing conditions may be detected before said change affects the plant growth and/or wellbeing of the plant.

Preferably, the measuring is performed at providing the growth media and/or ferrate to the growth substrate, and/or at an outlet, and/or the difference between an inlet and outlet may be measured, and/or the growth media may be measured at an interval.

In addition, said measurement(s) enable(s) to tune the reaction conditions automatically or manually by a controller. Therefore, optimal growing conditions may be achieved and the yield may be optimised.

In a further presently preferred embodiment according to the invention, the pH of the growth media may be in the range of 3 to 10, preferably in the range of 4 to 8, more preferably in the range of 5 to 8, even more preferably in the range of 5 to 7.5, even more preferably in the range of 5 to 7, even more preferably in the range of 6 to 7, most preferably about 6.5.

In a preferred embodiment the pH of the growth media may be in the range of 5 to 6.5, preferably in the range of 5.5 to 6.5, more preferably about 6.

It was found that the optimal acidity level (pH) for growing leaf vegetable plants and/or herb plants and/or potato pants with the method according to the invention is in the range of 5 to 8. Providing ferrate to the growing media enables to achieve the desired acidity level.

In a further presently preferred embodiment according to the invention, the temperature of the growth media may be in the range of 0° C. to 40° C., preferably in the range of 10° C. to 30° C., more preferably in the range of 15° C. to 28° C., most preferably in the range of 15° C. to 22° C.

In a preferred embodiment, the method according to the invention comprises the step of growing the leaf vegetable seeds and/or herb seeds and/or potato plant seeds and/or leaf vegetable plants and/or herb plants and/or potato plants at a temperature in the range of 0° C. to 40° C., preferably in the range of 10° C. to 30° C., more preferably in the range of 15° C. to 28° C., most preferably in the range of 15° C. to 22° C.

Growth media and/or growing the leaf vegetable seeds and/or herb seeds and/or potato plant seeds and/or leaf vegetable plants and/or herb plants and/or potato plants, at a temperature in the range of 0° C. to 60° C., preferably in the range of 0° C. to 40° C., more preferably in the range of 10° C. to 30° C., even more preferably in the range of 15° C. to 28° C., most preferably in the range of 15° C. to 22° C. provides optimal growing conditions for the leaf vegetable seeds and/or herb seeds and/or potato plant seeds and/or leaf vegetable plants and/or herb plants and/or potato plants. As a result, leaf vegetables and/or herbs and/or potato plants suitable for consumption are achieved in an efficient, effective, and environmental friendly manner.

In a further presently preferred embodiment according to the invention, the growth substrate may be part of an aqua based growth system.

Growing the leaf vegetables and/or herbs and/or potato plants in an aqua based growth system enables growth without soil. An advantage is that the rate of plant growth is increased. As a result, the yield of consumable leaf vegetables and/or herbs and/or potato plants per square meter is increased.

A further advantage of the growth substrate part of an aqua based growth system is that virus infections, fungi infections, and the like may be prevented as growing media in an aqua based system may be discomposed of unwanted particles and/or organisms. It is noted that soil is harder to discomposed of unwanted particles and/or organisms compared to a liquid such as water.

In a further presently preferred embodiment according to the invention, the fertilizer comprises organomineral fertilizer comprising one or more elements selected from the group of boron, calcium, magnesium, manganese, nitrogen, phosphorus, potassium, silicon, sodium, and sulphur.

It was found that a fertilizer comprising an organomineral fertilizer comprising one or more elements selected from the group of boron, calcium, magnesium, manganese, nitrogen, phosphorus, potassium, silicon, sodium, and sulphur, achieved efficient and effective leaf vegetable and/or herb and/or potato plant growth.

The invention also relates to a device for growing leaf vegetable, comprising:
a housing;
a dispenser that is connected to, or at least partially integrated in the housing;
an inlet that is connectable to a source of ferrate (VI), or a container for holding ferrate (VI); and
a control unit configured for controlling an amount of ferrate (VI) to be dispensed.

The device provides the same or similar effects and advantages as those described for the method according to the invention.

The device according to the invention enables to grow leaf vegetables and/or herbs and/or potato plants in an efficient and effective manner. In addition, the dispenser and/or control unit enables to stabilise the acidity level in the growth media. Therefore, an optimal environment may be achieved and dying of plants is prevented.

In a presently preferred embodiment according to the invention, the amount of ferrate (VI) may be ferrate (VI) powder, wherein the device further comprises a dissolver for dissolving ferrate (VI) powder in a liquid, preferably water, and wherein the control unit may be configured to control an amount of ferrate (VI) powder to be dispensed into a predetermined amount of water.

An advantage of ferrate (VI) powder is that transportation of the ferrate (VI) is reduced. Therefore, the carbon footprint of the device according to the invention is reduced.

The invention also relates to a system for growing leaf vegetables and/or herbs and/or potato plants, the system comprising:
at least one device according to the invention; and
at least one holding unit configured for holding a growth substrate and growth media.

The system provides the same or similar effects and advantages as those described for the method and the device according to the invention.

In a presently preferred embodiment according to the invention, the system comprises a system control unit that may be configured for controlling parameters of the at least one holding unit. Preferably, the system further comprises at least one sensor configured for measuring one or more parameters selected from the group of temperature, pH, nutrient level, flow, and volume of the growth media, and wherein the system control unit may be configured to control one or more of the temperature, pH, nutrient level, flow, and volume of the growth media based on measurement data from at least one sensor.

Controlling the different growing parameters enables to optimise the growing condition for the leaf vegetables and/or herbs and/or potato plants, and thus obtain an optimal yield.

In a further presently preferred embodiment according to the invention, the system control unit comprises at least one processing unit that may be configured for processing data, wherein the data preferably includes measurement data, such as sensor-based measurement data, and/or user input.

In a further presently preferred embodiment according to the invention, the at least one holding unit comprises a panel for cultivating plants, the panel comprising a plurality of through-holes extending through the panel from a first plane to a top side of a second plane, and at least one air chamber at the lower side thereof and arranged to allow the formation of plant roots. Preferably, the panel preferably is a floating panel, or a panel configured to be at least partially submerged when placed on a surface of a liquid.

In a further presently preferred embodiment according to the invention, the system further comprises at least one pump, wherein the at least one pump may be configured for circulating growth media in at least one holding unit.

The invention also relates to a use of ferrate for growing leaf vegetables and/or herbs and/or potato plants.

The use of ferrate for growing leaf vegetables and/or herbs and/or potato plants provides the same or similar effects and advantages as those described for the method, the device, and the system according to the invention.

In a presently preferred embodiment according to the invention, the leaf vegetable may be spinach.

In a further preferred embodiment according to the invention, the herb may be one or more selected from the group of coriander, dill, and parsley.

In a further presently preferred embodiment according to the invention, wherein the ferrate may be ferrate (VI).

The invention also relates to a use of ferrate for growing leaf vegetables and/or herbs and/or potato plants with the method according to the invention.

The use of ferrate for growing leaf vegetables and/or herbs and/or potato plants with the method according to the invention provides the same or similar effects and advantages as those described for the method, the device, the system, and the use of ferrate for growing leaf vegetables and/or herbs and/or potato plants according to the invention.

For example, the method according to the invention may be used/applied in indoor farming, plastic greenhouses, greenhouses, greenhouses covered with plastic, indoor farming, and/or vertical farming.

Further advantages, features and details of the invention are elucidated on the basis of preferred embodiments thereof, wherein reference is made to the accompanying drawings, in which:

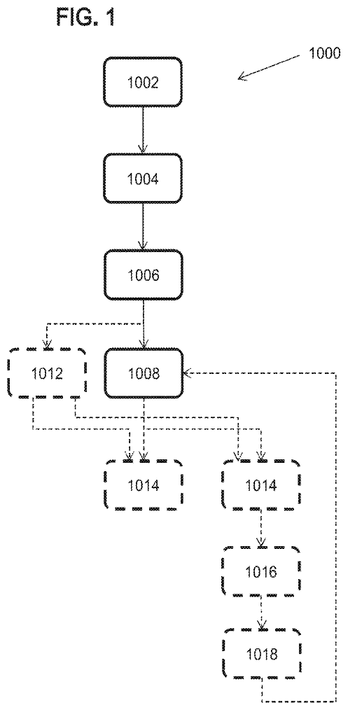

FIG. 1 shows a schematic example of the method according to the invention;

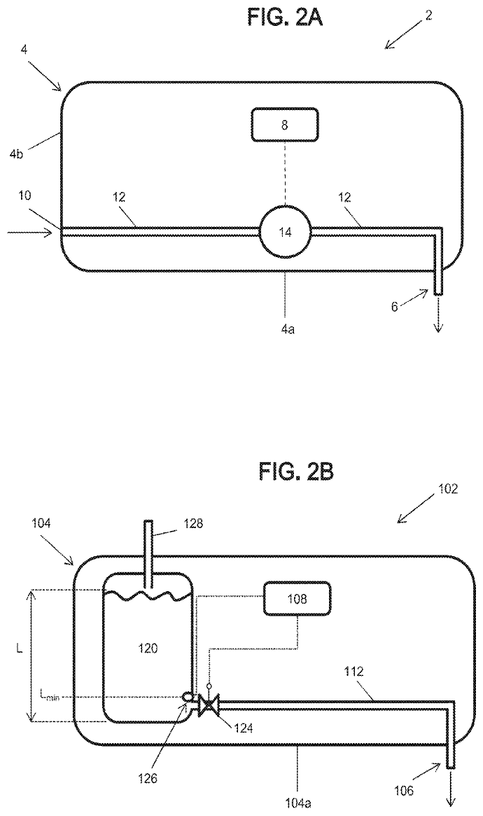

FIGS. 2a, 2b, 2c show a schematic view of several examples of the device according to the invention; and

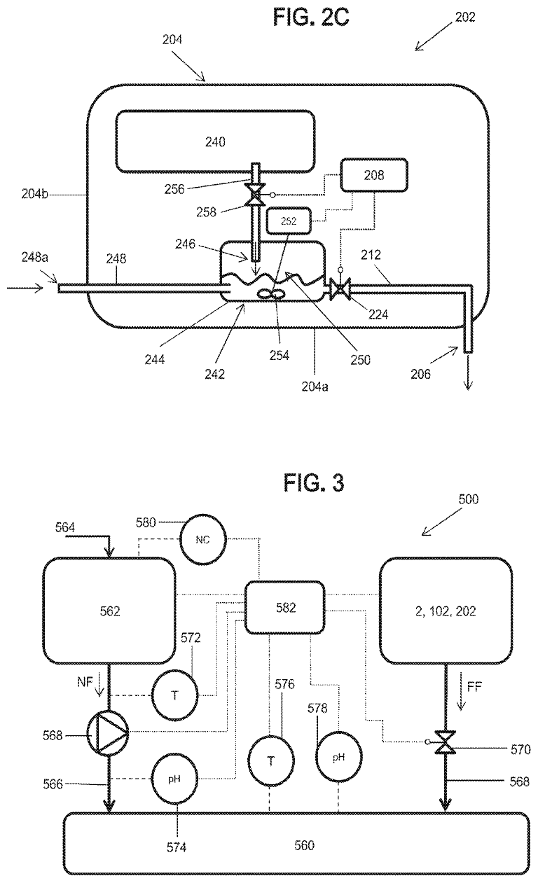

FIG. 3 shows a schematic example of the system according to the invention.

In an example of method 1000 for growing leaf vegetables and/or herbs and/or potato plants (see FIG. 1), method 1000 comprises the step of providing 1002 a growth substrate and providing 1004 one or more leaf vegetable seeds and/or herb seeds and/or potato plant seeds and/or leaf vegetable plants and/or herb plants and/or potato plants to growth substrate. The growth substrate thus forms the basis on which the leaf vegetable plants and/or herb plants and/or potato plants can grow over time. The growth substrate may be part of an aqua based growth system, and may for example be a floating substrate or base, a semi-sinkable substrate or even a substrate configured to be complete submerged during the grow period of the leaf vegetable. Combinations of such substrates may also be possible, for example in the form of a substrate that floats in early stages of growth and, during the grow period of the plants, slowly sinks under the weight of the growing plants. The vegetable leaf plants according to method 1000 may for example be spinach plants (or seeds).

Method 1000 further comprises the step of providing 1006 growth media to the one or more leaf vegetable seeds and/or herb seeds and/or potato plant seeds and/or leaf vegetable plants and/or herb plants and/or potato plants, wherein the growth media at least comprises a liquid. It is preferred that the growth media at least comprises a liquid, such as water, as most plants require (large amounts of) liquid and/or water to be enabled to grow. The growth media may, aside from liquid, which is preferably water, also contain one or more other substances, such as fertilizer, nutrients and/or stabilizers.

Method 1000 also comprises the step of providing 1008 ferrate to the growth media. The addition of ferrate, preferably ferrate (VI), provides the advantage that it stabilizes the growth media, and especially a balance of difference compounds therein. More specifically, it has been found that the method of growing plants benefits from the addition of ferrate in that it helps to maintain a balance between nutrients and pH of the liquid in the growth media. The assimilation or uptake of nutrients by the seeds or plants changes the composition of the growth media, especially when water with nutrients is used. This leads to an instability that changes for example the pH by acidifying the liquid (decrease in pH-value). It has been found that the addition of Ferrate, especially to the growth media, stabilizes the growth media, therewith optimizing the growth conditions for the plants.

The step of providing 1008 ferrate in this example comprises providing a quantity of ferrate preferably in the range of 1 cc m⁻³ liquid to 100 cc m⁻³ liquid. Furthermore, the step of providing 1006 growth media optionally comprises the step of providing 0.7 to 1.3 litre of liquid to 1 kilogram of harvestable spinach. In this example, the step of providing ferrate to the growth media comprises the optional step 1012 of dissolving the ferrate in a solvent, preferably wherein the solvent is water.

Another optional step in method 1000 is the step of measuring 1014 one or more selected from the group of temperature, pH, nutrient level, flow, and volume of the growth media. Measurements can be taken at appropriate locations. This provides a user with information on the status of the growth media and, therewith, indirectly of the plants and/or plant growth.

Together with the additional step of measuring 1014, method 1000 may optionally also include that the steps of comparing 1016 one or more of the measured values against one or more threshold values, such as an upper and lower threshold value, and establishing 1018 whether the measured value is within a threshold range. Additionally, the method may comprise the step of providing 1008 or supplying 1008 a predetermined quantity of ferrate to correct the values of the parameters that were concluded to be outside the threshold range. These steps allow (an even more) in-depth regulation of step 1008, because the quantity of ferrate can be adapted to the specific requirements that follow from the measuring.

In an example of device 2 according to the invention (see FIGS. 2a, 2b, 2c), device 2, 102, 202 comprises housing 4, 104, 204, which in side wall 4a, 104a, 204a thereof is provided with dispenser 6, 106, 206 that is connectable to and/or at least partially insertable in a growth system for growing leaf vegetables and/or herbs and/or potato plants. Furthermore, device 2, 102, 202 comprises control unit 8, 108, 208 for controlling an amount of ferrate to be dispensed. The dispensing is preferably measured in an amount per time unit, such as grams/second, cc/second or a similar parameter.

In a first example (see FIG. 2a), device 2 further comprises inlet 10 that is positioned in side wall 4b of housing 4 and that is connectable to a source of ferrate for providing ferrate to device 2. Device 2 further comprises transport unit 12, for example flow channel 12 or conveyor belt 12 that extends between inlet 10 and dispenser 6. Transport unit 12 is configured to transport ferrate, which may be dissolved ferrate or ferrate powder, from inlet 10 to dispenser 6. Device 2 further comprises control unit 8 for controlling the amount of ferrate to be dispensed per (predetermined) time unit to dispenser 6. In addition, device 2 in this example comprises optional regulator 14, which is configured to selectively open and close transport unit 12 for transportation of ferrate through device 2. This is may for example be a shut-off valve in case transport unit 12 is a flow channel configured to transport a liquid with dissolved ferrate therein.

In a second example (see FIG. 2b), device 102 comprises container 120 which is configured to hold ferrate. The ferrate in this example is dissolved in a liquid to provide a ferrate-containing liquid. Container 120 is connected to dispenser 106 via flow channel 122, which is provided with regulator 124, which in this example is shut-off valve 124. Shut-off valve 124 is operatively connected to control unit 108, which is configured to open or close shut-off valve 124 to supply ferrate to a growth system (not shown). Optionally, device 102 is provided with level sensor 126, which is configured to measure a liquid level in container 120. In this case, control unit 108 is further configured to provide a signal to a user, for example an audible and/or visible alarm, if liquid level L in container 120 drops below a predetermined threshold level Lₘᵢₙ. Furthermore, device 102 may be provided with optional inlet 128 for providing dissolved ferrate (i.e. a solution containing ferrate) to container 120. It may however also be possible to swap out container 120 if the liquid level in container 120 drops below liquid level Lₘᵢₙ.

In a third example (see FIG. 2c), device 202 comprises ferrate container 240 which is configured to hold ferrate powder. Device 202 further contains supply channel 248 that extends through housing wall 204b towards dissolver 242 of device 202. Other end 248a of supply channel 248 is connectable to a fluid source, such as a water supply. Dissolver 242 in this example comprises container 244 in which supply opening 246 of ferrate container 240 emanates. Supply channel 248 also emanates in container 244 to supply liquid, such as water, thereto. Device 202 in this example also comprises optional mixing unit 250, which comprises mixer 254 and motor 252. the operation of motor 252, and therewith of mixing unit 250, is controlled by control unit 208. In addition, supply channel 256 that extends between container 244 and ferrate container 240 is in this example provided with optional valve 258 or closure 258, which is also controlled by control unit 208. In use, control unit 208 simultaneously controls closure 258, motor 252 and mixing unit 250 as well as valve 224 to dispense ferrate to flow channel 212 and dispenser 206.

In an example of system 500 according to the invention, system 500 comprises at least one holding unit 560. Holding unit 560 may be a growth substrate 560, an aqua-culture based growing system 560 or any other unit 560 suitable for growing leaf vegetable plants and/or herb plants and/or potato plants. Holding unit 560 as such forms the basis for growing the leaf vegetable plants and/or herb plants and/or potato plants and is provided with growth media, which preferably includes a liquid such as water. System 500 is further provided with nutrient supply 562, which is operatively connected to holding unit 560. In this example, nutrient supply 562 is provided with nutrient inlet 564 and outlet 566, which is connected to holding unit 560. Outlet 566, which is in this example formed as outlet channel 566 is provided with dosing pump 568 to control the flow of nutrients to holding unit 560 and the seeds or plants contained therein. System 500 further comprises device 2, 102, 202 according to the invention, which is operatively coupled to holding unit 560. In this example, device 2, 102, 202 is coupled to holding unit 560 by means of ferrate supply 568 that extends between them. Ferrate supply 568 is provided optional regulator 570 to regulate the supply of ferrate to holding unit 560. It is noted that such a regulator can also be contained in device 2, 102, 202 in which case it is not required (see also FIGS. 1, 2a, 2b, 2c).

System may further comprise one or more sensors, which in this example are sensors 572, 574, 576, 578, 580. Sensors 572, 574 are configured to respectively measure temperature and pH-value of the nutrient supply in outlet channel 566. Sensors 576, 578 are configured to respectively measure temperature and pH-value in holding unit 560. Sensor 580 is configured to measure a nutrient concentration in nutrient supply 562.

System 500 further comprises system control unit 582, which is configured to control system 500. In particular, system control unit 582 is configured to receive and process measurement data from sensors 572, 574, 576, 578, 580 and to, at least partially based on the measurement data, control a nutrient flow NF and/or a ferrate flow/supply FF to holding unit 560, by respectively controlling dosing pump 568 and regulator 570 and/or device 2, 102, 202.

The present invention is by no means limited to the above described preferred embodiments and/or experiments thereof. The rights sought are defined by the following claims within the scope of which many modifications can be envisaged.

1. A method for growing leaf vegetables and/or herbs and/or potato plants, comprising the steps of:
providing a growth substrate;
providing one or more leaf vegetable seeds and/or herb seeds and/or potato plant seeds and/or leaf vegetable plants and/or herb plants and/or potato plants to a growth substrate;
providing growth media to the one or more leaf vegetable seeds and/or herb seeds and/or potato plant seeds and/or leaf vegetable plants and/or herb plants and/or potato plants, wherein the growth media at least comprises a liquid; and
providing ferrate to the growth media.

2. The method according to claim 1, wherein the growth media comprise one or more selected from the group of water, fertilizer, nutrients, stabilizers.

3. The method ethod according to claim 1, wherein the quantity of ferrate is in the range of 0.01 cc m⁻³ liquid to 1000 cc m⁻³ liquid.

4. The method according to claim 1, wherein the leaf vegetable seeds and/or leaf vegetable plants is spinach.

5. The method according to claim 4, wherein the step of providing growth media comprises the step of providing 0.7 to 1.3 litre of liquid to 1 kilogram of harvestable spinach.

6. The method according to claim 1, wherein the step of providing ferrate to the growth media comprises the step of dissolving the ferrate in a solvent.

7. The method according to claim 1, wherein the ferrate is ferrate (VI).

8. The method according to claim 1, further comprising the step of measuring one or more selected from the group of temperature, pH, nutrient level, flow, and volume of the growth media.

9. The method according to claim 1, wherein the pH of the growth media is in the range of 3 to 10.

10. The method according to claim 1, wherein the temperature of the growth media is in the range of 0° C. to 60° C.

11. The method according to claim 2, wherein the nutrient level is in the range of 1 mM to 100 mM.

12. The method according to claim 1, wherein the growth substrate is part of an aqua based growth system.

13. The method according to claim 1, wherein the fertilizer comprises organomineral fertilizer comprising one or more elements selected from the group of boron, calcium, magnesium, manganese, nitrogen, phosphorus, potassium, silicon, sodium, and sulphur.

14. A device for growing leaf vegetables and/or herbs and/or potato plants, comprising:
a housing;
a dispenser that is connected to, or at least partially integrated in the housing;
an inlet that is connectable to a source of ferrate (VI), or a container for holding ferrate (VI); and
a control unit configured for controlling an amount of ferrate (VI) to be dispensed.

15. The device according to claim 14, wherein the amount of ferrate (VI) is ferrate (VI) powder, wherein the device further comprises a dissolver for dissolving ferrate (VI) powder in a liquid, preferably water, and wherein the control unit is configured to control an amount of ferrate (VI) powder to be dispensed into a predetermined amount of water.

16. A system for growing leaf vegetables and/or herbs and/or potato plants, the system comprising:
at least one device according to claim 14; and
at least one holding unit configured for holding a growth substrate and growth media.

17. The system according to claim 16, wherein the system comprises a system control unit that is configured for controlling parameters of the at least one holding unit.

18. The system according to claim 17, further comprising at least one sensor configured for measuring one or more parameters selected from the group of temperature, pH, nutrient level, flow, and volume of the growth media, and wherein the system control unit is configured to control one or more of the temperature, pH, nutrient level, flow, and volume of the growth media based on measurement data from at least one sensor.

19. The system according to claim 17, wherein the system control unit comprises at least one processing unit that is configured for processing data.

20. The system according to claim 16, wherein the at least one holding unit comprises a panel for cultivating plants, the panel comprising a plurality of through-holes extending through the panel from a first plane to a top side of a second plane, and at least one air chamber at the lower side thereof and arranged to allow the formation of plant roots.

21. The system according to claim 20, wherein the panel preferably is a floating panel, or a panel configured to be at least partially submerged when placed on a surface of a liquid.

22. The system according to claim 16, further comprising at least one pump, wherein the at least one pump is configured for circulating growth media in at least one holding unit.

23-26. (canceled)
